(19) United States
(12) Patent Application Publication
(10) Pub. No.: US 2009/0183229 A1
(43) Pub. Date: Jul. 16, 2009

(54) License Authentication Device and License Authentication Method

(75) Inventor: Shinji Ohnishi, Kanagawa-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/569,470

(22) PCT Filed: Sep. 13, 2006
(86) PCT No.: PCT/JP26/18545

§ 371 Date: Nov. 21, 2006

(30) Foreign Application Priority Data
Sep. 13, 2005 (JP) 2005-266096

(51) Int. Cl. H04L 9/32; G06F 21/00

(52) U.S. Cl. 726/2

(57) ABSTRACT

A user-specific information is generated from unique information of an external device. A determination is made as to whether an entered license key has been generated based on the user-specific information. As a result of the determination, if the license key has been generated based on the user-specific information, the entered license key is authenticated as a correct license key.

### TECHNICAL FIELD

The present invention relates to a license authentication device and a license authentication method for performing software license authentication.

### BACKGROUND ART

Conventionally, especially in commercial software, it has been proposed to perform license authentication in order to grant a software license only to those who have purchased the license (see Japanese Patent Laid-Open No. 2003-174446). As to the methods for the license authentication, software methods and hardware methods are known. The former include a method by entering a serial number or a license authentication key on a license authentication screen, or by requesting an external system such as a licensing server to issue a license key. The latter include a method for performing license authentication by detecting particular hardware, such as a USB memory, (also called hardware key or dongle) which records software-specific information.

In a method which requires a license key provided in a license agreement, etc. to be entered, a combination of alphanumeric characters created according to a predefined rule is provided to a user as a license key. In addition, the software for which a license is authenticated previously includes a function of determining whether or not the license key entered by the user on the license authentication screen complies with the predefined rule, and authenticates based on the determination result.

If an external system is used, the software to be licensed first collects information specific to a system in which the software has been installed, such as network card information or CPU information. It sends the collected information to an external license key issuing system by some means, such as via a network connection, to request the system to issue a license key. The license issuing system issues the license key according to a predefined rule based on the received specific information. The issued license key is provided to the user, for example, by e-mail or via a Web browser screen and the user enters the issued license key on the authentication screen.

The software for which the license is authenticated validates the consistency between the entered license key and the information specific to its system sent to the licensing system. If the entered license key corresponds to the system-specific information, the software authenticates the license as an authorized license.

If particular hardware is used, the user previously connects a hardware key to the computer before launching software. The software detects and validates the hardware key when it is launched, and if a legitimate hardware key can be detected, the software determines that it is being used based on an authorized license and is normally launched. On the other hand, if the hardware key cannot be detected or the hardware key is not legitimate, the software terminates launching.

However, the method which requires a license key provided in a license agreement to be entered and a license key verification function incorporated in software is used to perform authentication has the following problem; this method allows one license key to be used for the authentication of software installed in a plurality of different environments. In recent years, software has been available which has a function of detecting an act of using a single license key for a plurality of computers within an identical network and protecting against unfair use (so-called network protect function). However, such software cannot restrict copying a license key in the other environments and cannot prevent against the unfair use of the software.

The copying of a license key can be blocked by a method using a license key issued based on the unique information of hardware in which the software is installed. However, if a part of the computer is changed or replaced, or the computer in which the software is installed should be changed, the correspondence between the license key and the hardware environment becomes inconsistent. In this case, in spite of having an authorized license, the use of the software becomes impossible. Therefore, a request for issuance of a license key has to be made again, which is inconvenience, and furthermore the software cannot be used until the new license key is issued.

In the method using a hardware key, the hardware key must always be connected to the computer, which is troublesome. In addition, when it is always connected, one of the computer interfaces is occupied and the extensibility is reduced. If the hardware key is lost or damaged, the software cannot be launched.

### DISCLOSURE OF INVENTION

The present invention is directed to overcome the above-described drawbacks and disadvantages. For example, the present invention is directed to protect against unfair use in a simple and friendly.

According to an aspect of the present invention, there is provided a license authentication device which authenticates a license of software used to control an external device, comprising: unique information obtaining unit adapted to obtain unique information of the external device from the external device; user-specific information generation unit adapted to generate user-specific information from the unique information; and determination unit adapted to determine whether a license key entered by a user corresponds to information that is generated from the user-specific information, wherein if it is determined by the determination unit that the license key corresponds to the information that is generated from the user-specific information, the license authentication device registers that the license of the software is authenticated.

According to another aspect of the present invention, there is provided a method of authenticating a license of software used to control an external device, the method comprising: obtaining unique information of the external device from the external device; generating user-specific information from the unique information; determining whether a license key entered by a user corresponds to information that is generated from the user-specific information; and registering that the license of the software is authenticated, if it is determined in the determining step that the license key corresponds to the information that is generated from the user-specific.

Further features and aspects of the present invention will become apparent from the following description of exemplary embodiments with reference to the attached drawings.

### BRIEF DESCRIPTION OF DRAWINGS

FIG. 1 is a flow chart illustrating the operation of a PC which acts as a license authentication device in the present exemplary embodiment;

FIG. 2 illustrates an exemplary GUI screen of DVC control software;

FIG. 3 is a flowchart illustrating license processing executed in step S105 of FIG. 1 in detail;

FIG. 4 illustrates an exemplary license registration information display screen;

FIG. 5 illustrates an exemplary error message display screen when a DVC is not detected;

FIG. 6 illustrates an exemplary verification screen when the license is not registered;

FIG. 7 illustrates an exemplary error message display screen when an unauthorized license key is entered;

FIG. 8 is a flow chart illustrating DVC control processing in step S106 of FIG. 1 in detail;

FIG. 9 is a block diagram illustrating the exemplary structure of the PC which acts as a license authentication device in the present exemplary embodiment; and

FIG. 10 is a sequence chart illustrating an exemplary procedure for a license authentication device in the present exemplary embodiment to access an external licensing server and obtain a license key.

### BEST MODE FOR CARRYING OUT THE INVENTION

Exemplary embodiments, features and aspects of the present invention will now be described in detail below with reference to the attached drawings.

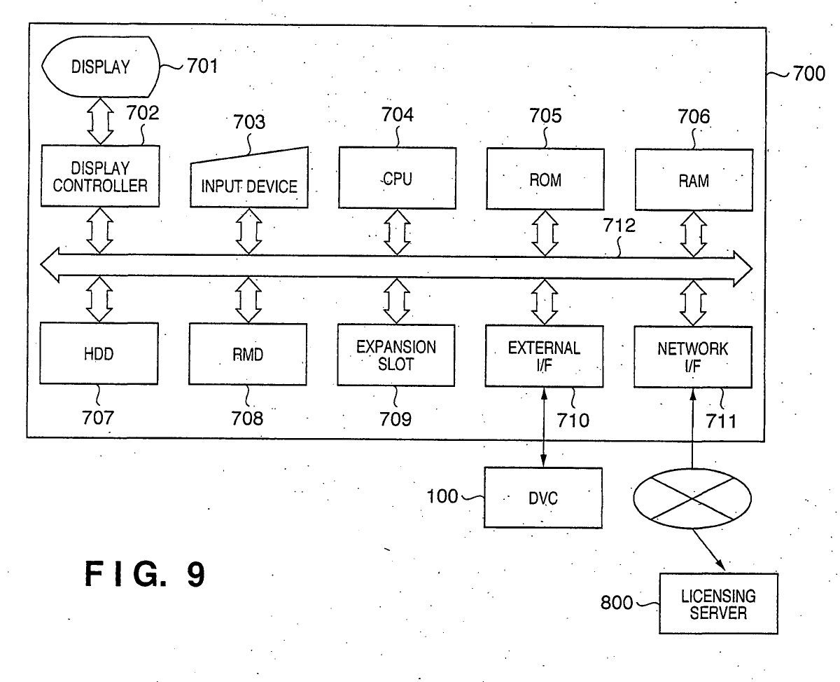

FIG. 9 is a block diagram illustrating the exemplary structure of a personal computer (PC) 700 which acts as a license authentication device in the present exemplary embodiment.

In the PC 700 in the present exemplary embodiment, software for controlling a digital video camera (DVC) 100, which is an external device having unique information, is installed. The software is referred to as DVC control software hereinafter. The PC 700 acts as a license authentication device according to the DVC control software. The DVC control software allows a user to use all of its functions if license registration, described later, is completed. On the other hand, the DVC control software allows the user to use a part of the functions. That is, for example, if the license registration is not completed, the user is allowed to use play and stop commands, but any of fast-forward, fast-rewind, and pause commands may not be allowed. In addition, the DVC control software changes the configuration of GUI (Graphical User Interface) depending on whether or not the license registration as described later is completed. The GUI includes a control panel for controlling the DVC 100.

A display 701 consists of a CRT (Cathode Ray Tube), an LCD (Liquid Crystal Display), etc. The display 701 displays GUIs, various messages and menus provided to the user by the DVC control software. A display controller 702 is responsible for control of the screen display on the display 701. An input device 703 is used for entering characters, pointing to an icon or a button in the GUI, and so forth. More specifically, the input device 703 includes, for example, a key board, mouse, trackball, joy stick, and touch panel. A CPU (Central Processing Unit) 704 governs the overall control of the PC 700.

A ROM (Read Only Memory) 705 stores programs or parameters executed by the CPU 704. A RAM (Random Access Memory) 706 is used as a work area for executing various programs by the CPU 704, a temporary save area for error processing, etc.

A hard disk drive (HDD) 707 and a removable media drive (RMD) 708 serve as external storage devices. The removable media drive is a device for reading and writing from and to or reading from a removable storage medium. The removable media drive 708 may be a flexible disk drive, optical disk drive, magneto-optical disk drive, memory card reader as well as a removable HDD.

Note that once the DVC control software is installed in the PC 700, it is stored at least in the HDD 707. Operating systems (OS), application programs such as a browser, data, libraries, etc. are stored in more than one of the ROM 705, the HDD 707, and the RMD 708, depending on the use.

An expansion slot 709 is a slot into which, for example, an expansion card conforming to the PCI (Peripheral Component Interconnect) bus standard is inserted. Into this expansion slot 709, a variety of expansion boards, such as an expansion video capture board, a sound board, or a GPIB board, can be inserted.

An external interface 710 is a communication interface conforming to the IEEE 1394-1995 standards and their enhanced standards.

A network interface 711 has a wired communication function conforming to the IEEE 802.3x (x is “i”, “u”, “z”, or “ab”), etc., or wireless communication function conforming to the IEEE 802.11a/b/g, Bluetooth (Registered Trademark), etc. A bus 712 consists of an address bus, a data bus and a control bus, and connects the above described units.

The PC 700 in the present exemplary embodiment can communicate with computers on a computer network, such as the Internet, via the network interface 711 by using the OS and required driver software, etc.

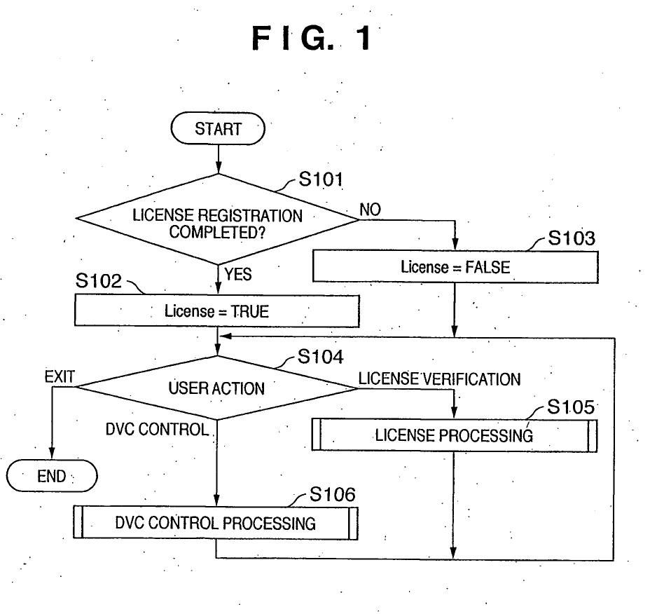

FIG. 1 is a flow chart illustrating the operation of the license authentication device in the present exemplary embodiment. This operation is started by the user launching the DVC control software on the PC 700.

When the user launches the DVC control software, the CPU 704 reads out the DVC control software stored in the HDD 707, etc., and loads it to the RAM 706 and executes it. In step S101, a determination is made as to whether or not the license registration is already completed. The information about the license registration is encrypted and stored, for example, in a configuration file, etc. in the HUD 707, and can be verified by referring to the stored information.

Based on the verification result in step S101, a value for an internal variable of the DVC control software, “License,” is set to a predetermined address of the RAM 706. The variable “License” is a Boolean type variable maintaining a value of TRUE or FALSE, and if the license registration is completed, it is set to TRUE in step S102, and if not, it is set to FALSE in step S103. At the initial launching of the DVC control software, since the license registration is not completed, the variable is set to FALSE in step S103.

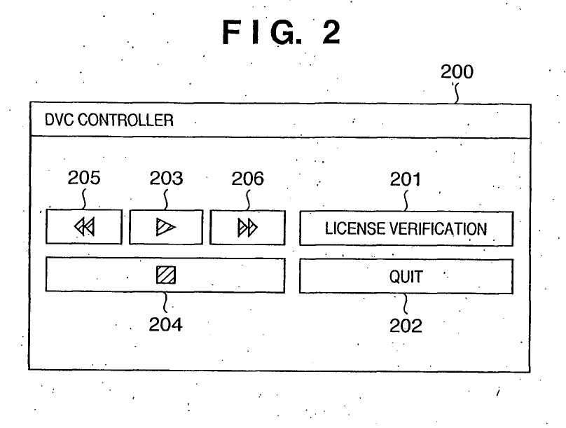

In step S104, the initial GUI screen of the application is presented on the display 701, and a user instruction (user action) via the input device 703 is awaited. FIG. 2 is an exemplary GUI screen of the DVC control software in the present exemplary embodiment. On the GUI screen 200, buttons 201 to 206 are arranged.

When the user operates an input device 203, e.g., a mouse, to move the mouse cursor onto a license verification button 201 and clicks on the mouse button, the CPU 704 detects the click on the license verification button 201 as a user action, and then proceeds to step S105. Note that, in the following description, the operation in which the mouse button is clicked with the mouse pointer being located on a button, it is represented as “the button is pressed.” In step S105, license processing as described later is performed, and then the process returns to step S104 and the next user action is awaited.

The buttons 203, 204, 205, and 206 in FIG. 2 are buttons for instructing control of DVC 100, respectively. When any of the buttons 203 to 206 are pressed, the CPU 704 detects a press of the DVC control button as a user action, and proceeds to step S106. In step S106, DVC control processing as described later is performed, and then the process returns to step S104 and the next user action is awaited.

The button 202 in FIG. 2 is a quit button, and when this button is pressed, the CPU 704 detects the press of the quit button as a user action and performs exit processing of the DVC control software.

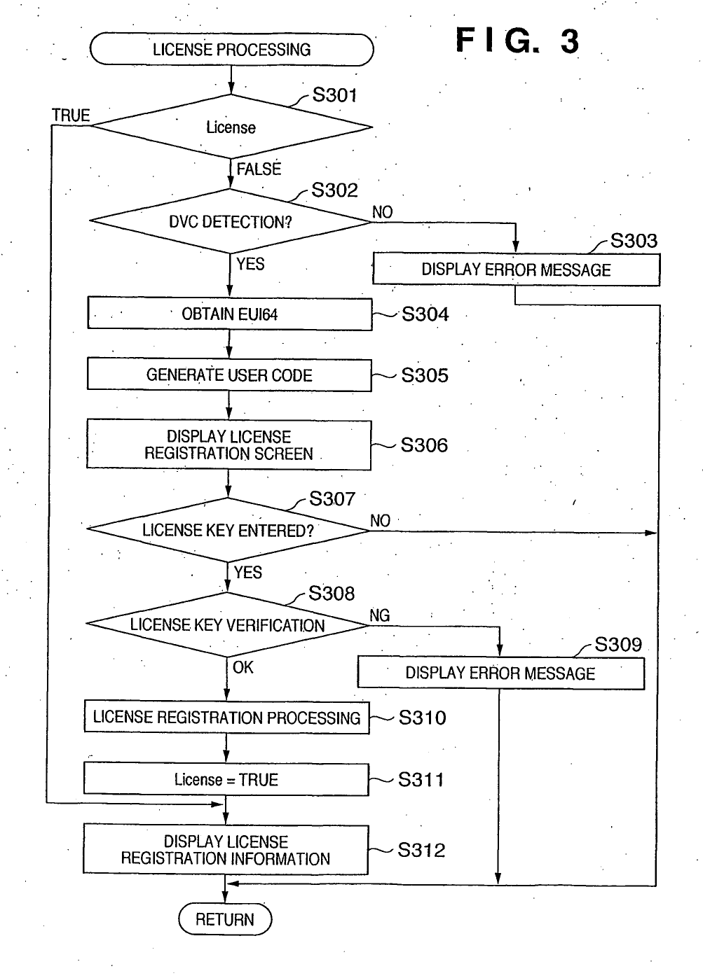

FIG. 3 is a flow chart illustrating the license processing executed in step S105 of FIG. 1 in detail.

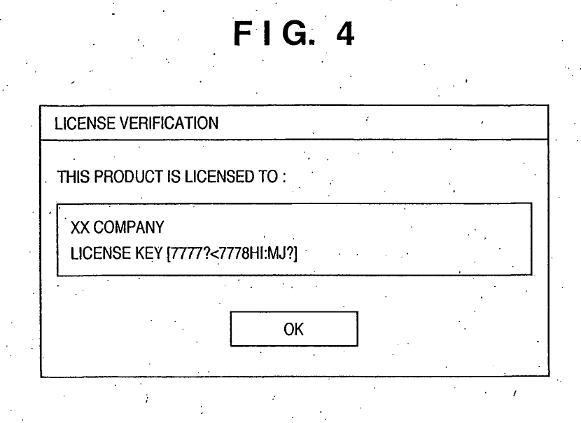

In step S301, the CPU 704 detects whether the license is registered or not with reference to the value of the variable “License” set in step S102 or in step S103. If the value of the variable “License” is TRUE, the license is registered, and a license registration information screen as shown in FIG. 4 is displayed in step S312. If the press of the OK button is detected, this processing is completed, and the process returns to step S104.

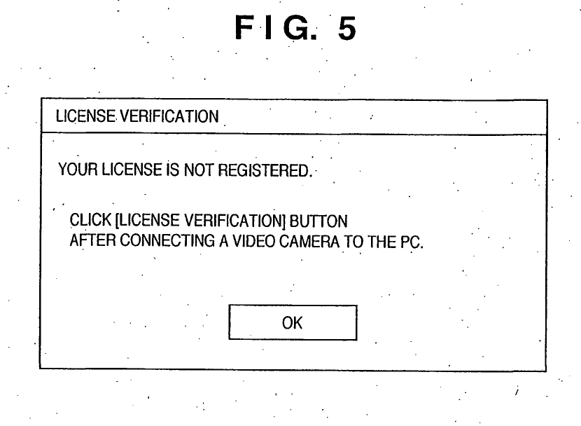

In step S301, if the value of the variable “License” is FALSE, the license is not registered, and thus the process proceeds to step S302 to check to see whether or not the DVC 100 is connected to the PC 700. If the DVC 100 is not connected to the external interface 710, the process proceeds to step S303, and an error message as shown in FIG. 5 is displayed on the display 701.

In step S302, if the connection of the DVC 100 is detected, in step S304 an unique ID (extended unique identifier-64: EUI64) carried by the DVC 100 is obtained. The EUI64 (extended unique identifier-64) is 8-byte (64-bit) data, and is an unique ID carried by a device equipped with an IEEE 1394 interface (IEEE 1394 device). That is, the value of the EUI64 is different from one IEEE 1394 device to another. The EUI64 can be obtained by accessing a particular area known as configuration ROM carried by the IEEE 1394 device. In the present exemplary embodiment, the value of the EUI64 carried by the DVC 100 is assumed to be an eight-byte hexadecimal, “0000850001AB3FC8.”

In step S305, the CPU 704 generates a user code as data unique to the user who owns the DVC 100 from the obtained value of the EUI64. The user code is data resulting from converting the value of the EUI64 using a predetermined algorithm. In the present exemplary embodiment, the character string resulting from taking the hexadecimal form of the EUI64 as a character string and adding 2 to the ASCII code value of each character is generated as a user code.

Although it is preferred that the predetermined algorithm cannot easily be decoded from the EUI64 and the generated user code, the present exemplary embodiment is described using the above described algorithm for ease of explanation. In the present exemplary embodiment, the EUI64 of the DVC 100 is “0000850001AB3FC8” and thus a character string resulting from the conversion according to the above described algorithm “2222:72223CD5HE:” is used as the user code.

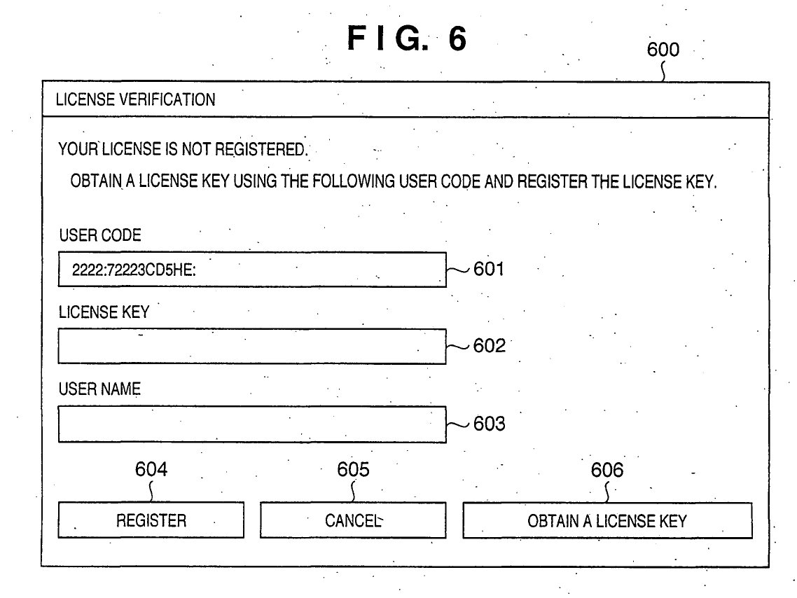

In step S306, the CPU 704 displays a license registration screen 600 as shown in FIG. 6 on the display 701. Reference numeral 601 denotes a user code display section, which displays the character string generated from the value of the EUI64 in step S305. The user code here is simply displayed, but the user is not allowed to directly enter or change it. Reference numeral 602 denotes a license key input section, reference numeral 603 denotes a user name input section, reference numeral 604 denotes a license registration button, and reference numeral 605 denotes a license registration cancel button. If the license registration cancel button 605 is pressed, the license processing is terminated. Reference numeral 606 denotes a license key obtaining button.

The user enters a license key in the license key input section 602 and any user name in the user name input section 603 on the license registration screen, respectively, using the input device 703.

The license registration can be performed by pressing the license registration button 604. The license key entered here is a character string generated from the user code.

The generation of the license key from the user code is performed through an external server, an automated telephone answering system or the like. For example, if the license key is issued by an external server, as shown in FIG. 9, an access is made to a licensing server 800 through the network interface 711 to receive the license key.

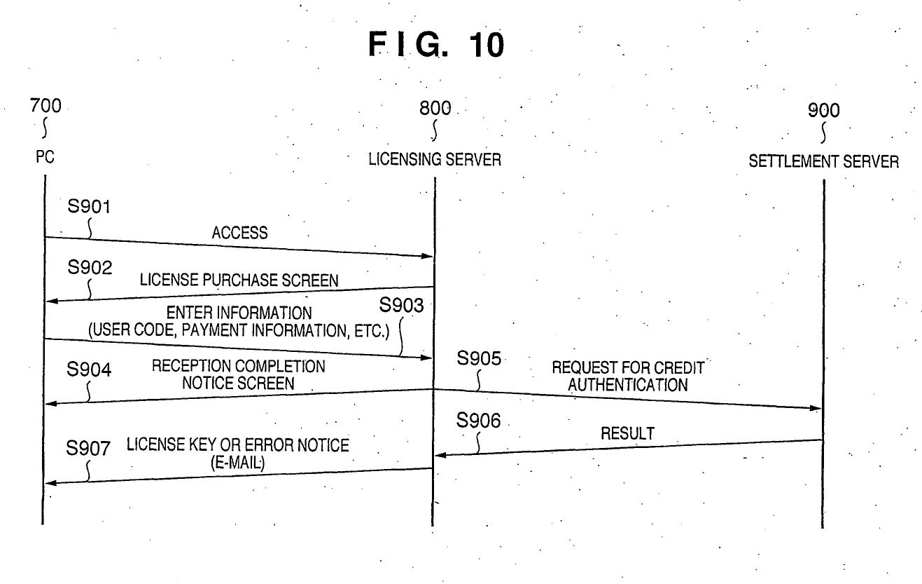

FIG. 10 is a sequence chart illustrating an exemplary procedure for the PC 700 to access an external licensing server through the network interface 711 and obtain a license key.

On the license registration screen in FIG. 6, when the license key obtaining button 606 is pressed, the CPU 704 launches, for example, a browser application from the HDD 707. Thereafter, the CPU 704 accesses the network address (e.g. URL) of the licensing server 800 (step S901). At this time, preferably, a secure connection, most notably HTTPS, is established.

The licensing server 800 sends to the PC 700 data of a form screen for getting information necessary for the issuance of the license entered (step S902). The information required to be entered in the form screen may include a user code and other information typically necessary for online payment, such as payment information (credit card information, etc.) or personal information (address, name, telephone number, e-mail address, etc.).

When the CPU 704 is instructed to send input data, for example, by pressing a send button contained in the form screen being displayed, it sends the information entered in the form to the licensing server 800 (step S903).

The licensing server 800 checks the form data for possible incompleteness such as missing data, and sends back a reception completion notice screen if there is no incompleteness (S904). Also, it uses the received data to request another settlement server 900 for credit authorization (S905). The settlement server 900 determines whether the owner of the credit card corresponds with the card number, whether there is any problem with the user's ability to pay, etc., for example, from the credit card information and a credit database, and notifies the licensing server 800 of the result (S906).

If no problem is found in the result of the credit, the licensing server 800 generates a license key from the user code and sends the license key to the e-mail address received in step S903 (S907). If there is a problem in the credit result, it also sends an e-mail stating as such.

In the present exemplary embodiment, the license key is data converted from the user code using a predetermined algorithm and in the present exemplary embodiment a character string resulting from adding 5 to the ASCII code value of each character of the user code is generated as the license key. Although it is preferred that the predetermined algorithm cannot easily be decoded from the user code and the generated license key, the present exemplary embodiment is described using this algorithm for ease of explanation.

In the present exemplary embodiment, the user code is “2222:72223CD5HE:” and thus the license key generated by the licensing server 800 will be “7777?<7778HI:MJ?.”

In the example of FIG. 10, after receiving the form data in step S903, the connection between the PC 700 and the licensing server 800 is closed and the license key is notified separately by e-mail. However, after receiving the form data, the connection may alternatively be maintained until the credit result is provided and the license notice screen may be sent in step S907. Of course, even in this case, the notice by e-mail may be sent in parallel.

Further, in a case, for example, where the license key cannot be obtained online, a well known automated telephone answering system can be used instead of the licensing server 800. In this case, the user uses the keypad of the telephone to enter the user code and the automated telephone answering system recognizes the user code based on the well known dial tone identification technology. The generated license key is notified by a synthesized voice.

Upon receipt of the license key by e-mail or by telephone, the user enters the license key in the license key input section 602 and the user name in the user name input section 603 on the license registration screen, and presses the license registration button 604.

Returning to FIG. 3, when the CPU 704 detects the press of the registration button 604, it verifies the consistency between the entered license key and the user code displayed in the user code display section 601 in step S308. In other words, the DVC control software in the present exemplary embodiment includes a functional module that executes a license key generation algorithm similar to that in the license key issuing server 800.

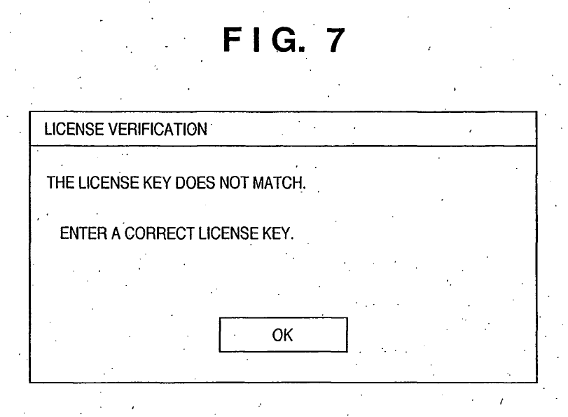

The CPU 704 generates the license key from the entered user code and determines whether or not the entered license key and the license key generated from the user code match. If they do not match, in step S309, an error message as shown in FIG. 7 is displayed. If they match, in step S310, license registration processing is performed for recording the license information in the configuration file, etc. After setting the variable “License” to TRUE in step S311, the license registration information as shown in FIG. 4 is displayed on the screen in step S312 and the process ends.

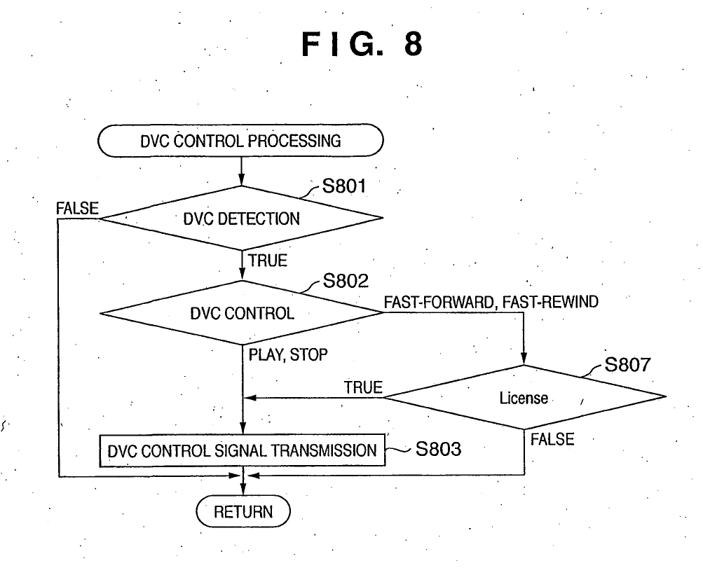

Next, the DVC control processing in step S106 of FIG. 1 is described in detail using the flow chart in FIG. 8.

In the GUI screen 200 of FIG. 2, if any of the DVC control buttons 203 to 206 is pressed, the process moves from step S104 to step S106, and the processing in FIG. 8 is started. First, in step S801, it is detected whether or not the DVC 100 is connected to the IEEE 1394 interface, as in step S302 of FIG. 3, and if no connection is detected, no processing is performed and the process returns to step S104.

On the other hand, if the connection of the DVC 100 is detected, the CPU 704 determines the type of the DVC control in step S802. If the play button 203 or the stop button 204 is pressed, the corresponding DVC control signal is sent to the DVC 100 in step S803. If the fast-rewind button 205 or the fast-forward button 206 is pressed, the value of the variable “License” is determined in step S807.

If the license is registered and the value of the variable “License” is TRUE, in step S803, a DVC control signal corresponding to the pressed button is sent to the DVC 100. If the license is not registered and the value of the variable “License” is FALSE, no processing is performed and the process ends to limit the function. It should be noted that at this time, in order to inform the user that the limitation is incurred because license registration is not completed, a message may be displayed, such as “This function is disabled because license registration is not completed. Click on the “License Verification” button to apply for license registration.”

As described above, according to the present exemplary embodiment, the license authentication of the DVC control software is performed using a user code generated based on the unique information of an external device and a license key generated based on the user code. Therefore, even if the license key alone is leaked, the DVC control software cannot be used without the user code from which the license key is derived. Furthermore, even if both of the user code and the license key are leaked, since an external device having particular unique information is required for generating the user code corresponding to the license key, the unfair use of the license key is effectively impossible.

On the other hand, if a user wants to use the DVC control software on a device other than the PC for which the license key has been obtained, the user can use the same license key to register the license by connecting the same external device.

Furthermore, on the PC on which the license registration has once been completed, even if the DVC software is used for another external device (for example, a DVC of a different model from that used for the registration), new license registration is not required.

In this way, the present exemplary embodiment can ensure that user-friendliness as well as prevention against unfair use of the DVC software is provided.

### Other Exemplary Embodiments

It should be noted that while in the above described embodiment a DVC is taken as an example of an external device having unique information, the present invention is similarly applicable to software license authentication which uses an external device having unique information other than the DVC.

Further, in the above described embodiment, by way of example, a license key is generated from a user code using an external device such as a license key generation server. However, as a matter of course, the license key can also be generated on the PC 700 and the advantage of the present invention can also be achieved in such a constitution.

When a computer program is provided and installed in a computer in order to cause the computer to achieve the functional processing of the present invention, the computer program itself is also deemed to embody the present invention. In other words, the computer program for achieving the functional processing of the present invention, itself, is also included in the present invention.

In that case, the program may be provided in any form, such as an object code, a program executed by an interpreter, script data provided to an OS, and so on, if only it has the function of the program.

In such a case, the computer program for causing a computer to achieve the functional processing of the present invention is provided to the computer by means of a recording medium or via wired/wireless communication. The recording medium for providing the program includes, for example, magnetic recording media such as flexible disks, hard disks, magnetic tapes, etc., optical/magneto-optical recording media such as MO, CD, DVD, etc., and non-volatile solid-state memories.

The method for providing the program via wired/wireless communication includes a method by making use of a server on a computer network. In this case, a data file which can be the computer program constituting the present invention (program data file) is previously stored in the server. The program data file may be an executable or may be a source code.

A client computer accessing this server is provided with the program by downloading the program data file. In this case, it is also possible to divide the program data file into a plurality of segment files and distribute the segment files among different servers.

In other words, the server device that provides the client computer with the program data file for achieving the functional processing of the present invention is also included in the present invention.

Alternatively, it is also possible to distribute recording media storing an encrypted computer program of the present invention to users, to provide the users who satisfy a predetermined condition with key information for decoding the encryption, and to allow the users to install the program in the computers owned by them. The key information can be provided, for example, by allowing the users to download from a Web page over the Internet.

Alternatively, the computer program for achieving the function of the above described embodiment may also use the function of an OS (operating system) already running on a computer to achieve the functions of the embodiment.

Furthermore, at least part of the computer program constituting the present invention may be provided as firmware of an expansion board, etc. mounted on a computer, and may use the CPU provided on the expansion board, etc. to achieve the function of the above described embodiment.

While the present invention has been described with reference to exemplary embodiments, it is to be understood that the present invention is not limited to the disclosed exemplary embodiments. The scope of the following claims is to be accorded the broadest interpretation so as to encompass all such modifications, equivalent structures and functions.

This application claims the benefit of Japanese Patent Application No. 2005-266096; filed Sep. 13, 2005, which is hereby incorporated by reference herein in its entirety.

1. A license authentication device which authenticates a license of software used to control an external device, comprising:
unique information obtaining unit adapted to obtain unique information of the external device from the external device;
user-specific information generation unit adapted to generate user-specific information from the unique information; and
determination unit adapted to determine whether a license key entered by a user corresponds to information that is generated from the user-specific information,
wherein if it is determined by the determination unit that the license key corresponds to the information that is generated from the user-specific information, the license authentication device registers that the license of the software is authenticated.

2. The license authentication device according to claim 1, wherein the user-specific generation unit generates the user-specific information based on the unique information, if the license authentication device detects that the external device is connected to the license authentication device.

3. The license authentication device according to claim 1, wherein if there is no record indicating that the license of the software is authenticated, the license authentication device limits a function of the software.

4. The license authentication device according to claim 1, wherein if there is a record indicating that the license of the software is authenticated, the license authentication device is not required to authenticate the license of the software even if another external device is connected to the license authentication device.

5. The license authentication device according to claim 1, wherein the unique information obtaining unit obtains the unique information from the external device using a communication unit conforming to IEEE 1394-1995 standard.

6. A method of authenticating a license of software used to control an external device, the method comprising:
obtaining unique information of the external device from the external device;
generating user-specific information from the unique information;
determining whether a license key entered by a user corresponds to information that is generated from the user-specific information; and
registering that the license of the software is authenticated, if it is determined in the determining step that the license key corresponds to the information that is generated from the user-specific.

7. A computer-readable recording medium storing a program that causes a computer to execute the method according to claim 6.
